(19) United States
(12) Patent Application Publication
(10) Pub. No.: US 2026/0128851 A1
(43) Pub. Date: May 7, 2026

(54) RADIO-FREQUENCY MODULE AND COMMUNICATION DEVICE

(71) Applicant: Murata Manufacturing Co., Ltd., Kyoto (JP)

(72) Inventors: Satoshi NAKAMURA, Nagaokakyo-shi (JP); Yoshiki NAKAGAWA, Nagaokakyo-shi (JP); Katsuya IKEGAMI, Nagaokakyo-shi (JP)

(21) Appl. No.: 19/375,604

(22) Filed: Oct. 31, 2025

(30) Foreign Application Priority Data
Nov. 5, 2024 (JP) 2024-193858

(51) Int. Cl. H04L 5/14; H04B 1/10

(52) U.S. Cl. CPC H04L 5/1469; H04B 1/1018

(57) ABSTRACT

A radio-frequency module includes first filters, a second filter, a first switch, a second switch, and a first variable circuit element. The first filters have a first pass band that includes a first communication band. The second filter has a second pass band that includes a second communication band. The first switch selects the connection destination of each of a plurality of antenna terminals from among first terminals of the first filters and the second filter. The second switch selects the connection destination of a second terminal of the second filter from among a first power amplifier and a first low-noise amplifier. The first variable circuit element is connected between the second filter and the second switch and shifts an attenuation band on the first pass band side in the second filter.

### CROSS REFERENCE TO RELATED APPLICATION

This application claims priority from Japanese Patent Application No. 2024-193858, filed on November 5, 2024. The content of these applications are incorporated herein by reference in its entirety.

### BACKGROUND OF THE DISCLOSURE

### 1. Field of the Disclosure

The present disclosure generally relates to a radio-frequency module and a communication device, and more particularly relates to a radio-frequency module that processes a first TDD signal in a first communication band and a second TDD signal in a second communication band, and a communication device including the radio-frequency module.

### 2. Description of the Related Art

A multiplexer described in Japanese Unexamined Patent Application Publication No. 2023-65416 includes a plurality of switches, a plurality of filters, a plurality of power amplifiers, and a plurality of low-noise amplifiers.

### BRIEF SUMMARY OF THE DISCLOSURE

In a front-end module such as the multiplexer described in Japanese Unexamined Patent Application Publication No. 2023-65416, the plurality of filters generally includes a filter for band 77 (n77, first communication band) and a filter for band 79 (n79, second communication band). The bands n77 and n79 are adjacent communication bands. Therefore, when transmission using n77 and reception using n79 are performed simultaneously, the transmission signal of n77 leaks into the reception path for n79, thereby degrading the reception sensitivity of n79. Furthermore, when communication is performed solely using n79, it is desirable to reduce degradation in the communication quality of n79.

In light of the above problems, a possible benefit of the present disclosure is to provide a radio-frequency module and a communication device that can realize reduced interference between adjacent first and second communication bands and reduced degradation of communication quality.

A radio-frequency module according to an aspect of the present disclosure processes a first TDD signal in a first communication band and a second TDD signal in a second communication band adjacent to the first communication band. A communication band of the first communication band is wider than a communication band of the second communication band. The radio-frequency module includes a first filter, a second filter, a first switch, a second switch, and a first variable circuit element. The first filter has a first pass band that includes the first communication band. The second filter has a second pass band that includes the second communication band. The first switch selects a connection destination for each of a plurality of antenna terminals from among first terminals of the first filter and the second filter. The second switch selects a connection destination for a second terminal of the second filter from among a first power amplifier and a first low-noise amplifier. The first variable circuit element is connected inside the second filter, inside the second switch, or between the second filter and the second switch, and shifts an attenuation band on the first pass band side in the second filter.

A communication device according to an aspect of the present disclosure includes the above-described radio-frequency module and a signal processing circuit. The signal processing circuit is connected to the radio-frequency module and performs signal processing on a radio-frequency signal.

The radio-frequency module and communication device according to the present disclosure have an advantage in that reduced interference can be realized between adjacent first and second communication bands while also realizing reduced degradation of communication quality.

### BRIEF DESCRIPTION OF THE SEVERAL VIEWS OF THE DRAWINGS

FIG. 1 is a block diagram of a radio-frequency module and a communication device according to Embodiment 1;

FIG. 2 is an explanatory diagram illustrating frequency characteristics of a second filter included in the radio-frequency module according to Embodiment 1;

FIG. 3 is a block diagram of a radio-frequency module and a communication device according to Embodiment 2;

FIG. 4 is a block diagram of a radio-frequency module and a communication device according to Embodiment 3;

FIG. 5 is an enlarged view of a main part of the radio-frequency module according to Embodiment 3;

FIG. 6 is a block diagram of a radio-frequency module and a communication device according to Embodiment 4;

FIG. 7 is a block diagram of a radio-frequency module and a communication device according to a modification of Embodiment 4;

FIG. 8 is a cross-sectional view of a radio-frequency module according to Embodiment 5; and

FIG. 9 is a plan view of a first main surface of a mounting substrate of the radio-frequency module according to Embodiment 5 as viewed in a direction perpendicular to the first main surface.

### DETAILED DESCRIPTION OF THE DISCLOSURE

### 1 Embodiment 1

A radio-frequency module 1 according to Embodiment 1 will be described in detail with reference to the drawings.

### 1-1 Overview

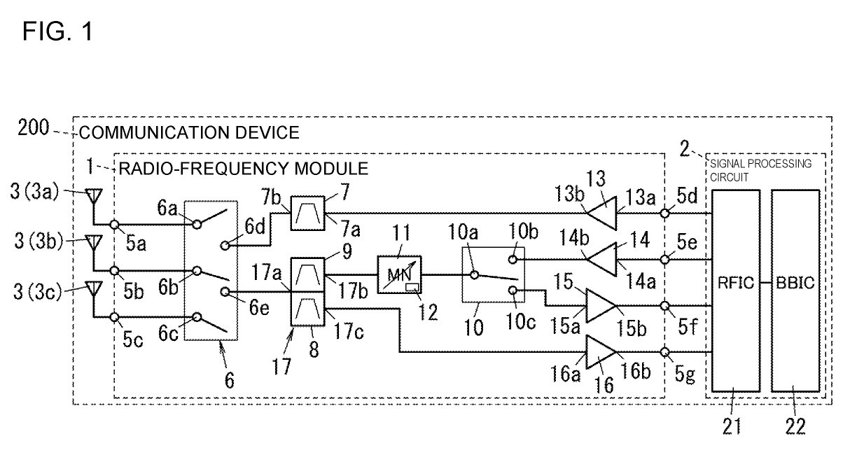

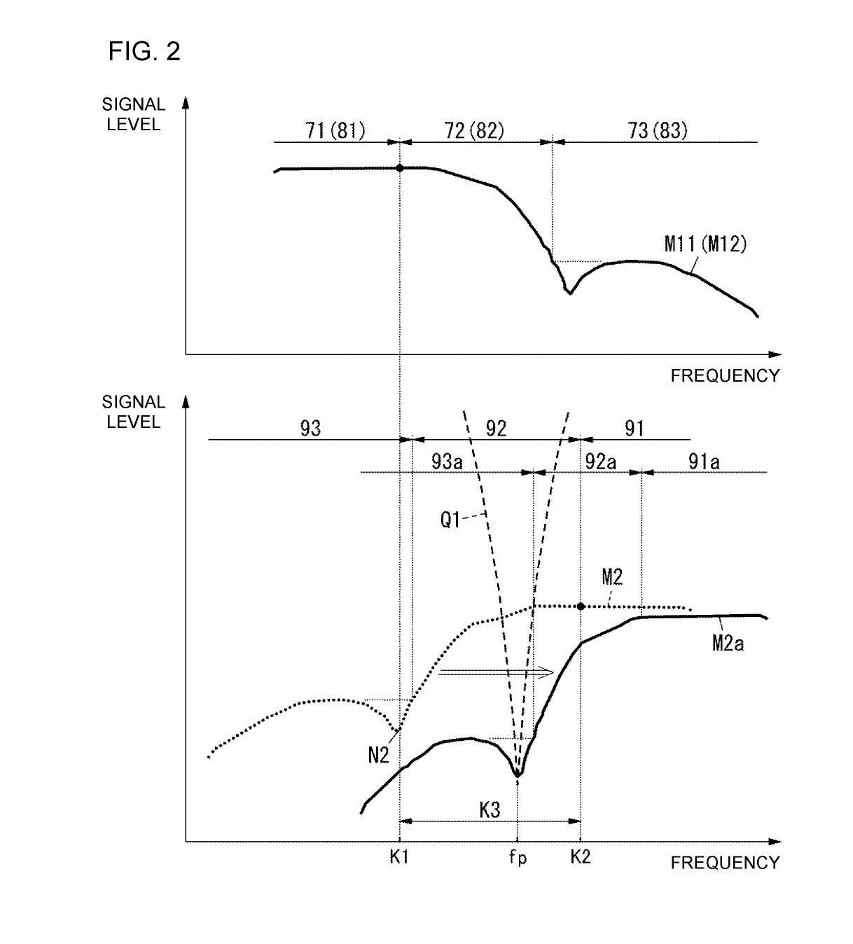

As illustrated in FIG. 1, the radio-frequency module 1 according to Embodiment 1 processes a first time division duplex (TDD) signal in a first communication band (e.g., n77) and a second TDD signal in a second communication band (e.g., n79). The communication band of the first communication band is wider than the communication band of the second communication band. The radio-frequency module 1 includes first filters 7 and 8, a second filter 9, a first switch 6, a second switch 10, and a first variable circuit element 12. The first filters 7 and 8 respectively have first pass bands 71 and 81 that include the first communication band (see FIG. 2). The second filter 9 has a second pass band 91 that includes the second communication band (see FIG. 2). The first switch 6 selects the connection destinations of first terminals 7b and 17a of the first filters 7 and 8 and the second filter 9 from among a plurality of antenna terminals 5a to 5c. The second switch 10 selects the connection destination of a second terminal 17b of the second filter 9 from among a power amplifier 14 (first power amplifier) and a low-noise amplifier 15 (first low-noise amplifier). The first variable circuit element 12 is connected inside the second filter 9, inside the second switch 10, or between the second filter 9 and the second switch 10 (in the example of FIG. 1, the first variable circuit element 12 is connected between the second filter 9 and the second switch 10). The first variable circuit element 12 shifts a second attenuation band 93 (see FIG. 2), which is on the side near the first pass bands 71 and 81, in the second filter 9.

Here, the TDD signals (first TDD signal and second TDD signal) are signals that undergo processing in which transmission and reception are switched between using time division duplexing. The first TDD signal is a TDD signal having a frequency within the first communication band. The second TDD signal is a TDD signal having a frequency within the second communication band.

According to this configuration, by shifting the second attenuation band 93, which is on the side near the first pass bands 71 and 81, in the second filter 9 using the first variable circuit element 12, it is possible to reduce the interference between the adjacent first and second communication bands while also reducing degradation of communication quality.

### 1-2 Configuration of Communication Device

As illustrated in FIG. 1, a communication device 200 is a communication device that includes the radio-frequency module 1. The communication device 200 is, for example, a mobile terminal (e.g., a smartphone), but is not limited to a mobile terminal and may be, for example, a wearable terminal (e.g., a smart watch). The radio-frequency module 1 is, for example, a module compatible with the 4G (fourth Generation Mobile Communication) standard and the 5G (fifth Generation Mobile Communication) standard. The 4G standard is, for example, 3GPP (registered trademark, third Generation Partnership Project) or the LTE standard (registered trademark, Long Term Evolution). The 5G standard is, for example, 5GNR (New Radio).

In addition to the radio-frequency module 1, the communication device 200 further includes a signal processing circuit 2 and a plurality of (three in the example in FIG. 1) antennas 3. When distinguishing between the three antennas 3, the three antennas 3 are referred to as a first antenna 3a, a second antenna 3b, and a third antenna 3c.

The radio-frequency module 1 is configured to amplify a transmission signal (radio-frequency signal) outputted from the signal processing circuit 2 and transmit the amplified transmission signal from one of the plurality of antennas 3. The radio-frequency module 1 is also configured to amplify a reception signal (radio-frequency signal) received by one of the plurality of antennas 3 and output the amplified reception signal to the signal processing circuit 2. The radio-frequency module 1 is controlled by, for example, the signal processing circuit 2.

The signal processing circuit 2 is connected to the radio-frequency module 1 and performs signal processing on radio-frequency signals. More specifically, the signal processing circuit 2 is configured to perform signal processing on transmission signals to be outputted to the radio-frequency module 1. The signal processing circuit 2 is also configured to perform signal processing on reception signals outputted from the radio-frequency module 1. The signal processing circuit 2 includes a radio frequency (RF) signal processing circuit 21 and a baseband signal processing circuit 22.

The RF signal processing circuit 21 is, for example, a radio frequency integrated circuit (RFIC), and performs signal processing on radio-frequency signals (transmission signals and reception signals). The RF signal processing circuit 21 performs signal processing such as up-conversion on the transmission signals outputted from the baseband signal processing circuit 22, and outputs the processed transmission signals to the radio-frequency module 1. The RF signal processing circuit 21 also performs signal processing such as down-conversion on the reception signals outputted from the radio-frequency module 1, and outputs the processed signals to the baseband signal processing circuit 22.

The baseband signal processing circuit 22 is, for example, a baseband integrated circuit (BBIC). The baseband signal processing circuit 22 generates a transmission signal from a baseband signal (for example, an audio signal and an image signal) inputted from the outside, and outputs the generated transmission signal to the RF signal processing circuit 21. The baseband signal processing circuit 22 also outputs a reception signal outputted from the RF signal processing circuit 21 to the outside. This output signal (reception signal) can be used, for example, as an image signal for image display or as an audio signal for telephone calls.

### 1-3 Configuration of Radio-Frequency Module 1

The radio-frequency module 1 processes the first TDD signal in the first communication band and the second TDD signal in the second communication band. The communication band of the first communication band is wider than the communication band of the second communication band. The second communication band is adjacent to the first communication band. Here, "the first communication band is adjacent to the second communication band" means that there are no other communication bands between the first communication band and the second communication band. The first communication band is, for example, n77, and the transmission band and reception band of the first communication band are the same frequency band, for example, 3300 MHz to 4200 MHz. The transmission band and reception band of the first communication band may be collectively referred to as a pass band. The second communication band is, for example, n79, and the transmission band and reception band of the second communication band are the same frequency band, for example, 4200 MHz to 5000 MHz. The transmission band and reception band of the second communication band may be collectively referred to as a pass band. The first communication band is a wide band, and the second communication band is a narrow band.

As illustrated in FIG. 1, the radio-frequency module 1 includes, for example, a plurality of external terminals 5a to 5g, the first switch 6, a plurality of (two in the example in FIG. 1) first filters 7 and 8, the second filter 9, the second switch 10, a variable matching network 11, the first variable circuit element 12, a plurality of (two in the example in FIG. 1) power amplifiers 13 and 14, and a plurality of (two in the example in FIG. 1) low-noise amplifiers 15 and 16. In the example in FIG. 1, the first filter 8 and the second filter 9 constitute a duplexer 17.

### 1-3-1 External Terminals

The external terminal 5a is an antenna terminal connected to the first antenna 3a. The external terminal 5b is an antenna terminal connected to the second antenna 3b. The external terminal 5c is an antenna terminal connected to the third antenna 3c. The external terminal 5d is connected to an output of the signal processing circuit 2 and is an input terminal to which the first TDD signal of the first communication band outputted from the output of the signal processing circuit 2 is inputted. The external terminal 5e is connected to an output of the signal processing circuit 2 and is an input terminal to which the second TDD signal of the second communication band outputted from the output of the signal processing circuit 2 is inputted. The external terminal 5f is connected to an input of the signal processing circuit 2 and is an output terminal that outputs the first TDD signal of the second communication band processed by the radio-frequency module 1 to an input of the signal processing circuit 2. The external terminal 5g is connected to an input of the signal processing circuit 2 and is an output terminal that outputs the second TDD signal of the second communication band processed by the radio-frequency module 1 to an input of the signal processing circuit 2.

### 1-3-2 First Switch 6

The first switch 6 is, for example, an antenna switch. The first switch 6 is a switch for selecting an antenna to be used for transmission or reception from among the plurality of antennas 3. The first switch 6 is controlled based on a control signal from a controller, which is not illustrated, in the radio-frequency module 1. The first switch 6 is, for example, a switch integrated circuit (IC).

The first switch 6 has a plurality of common terminals 6a to 6c (three in the example in FIG. 1) and a plurality of selection terminals 6d and 6e (two in the example in FIG. 1). Each of the plurality of common terminals 6a to 6c is selectively connected to one of the plurality of selection terminals 6d and 6e. The plurality of common terminals 6a to 6c are respectively connected to the plurality of external terminals 5a to 5c. The selection terminal 6d is connected to an output 7b of the first filter 7. The selection terminal 6e is connected to a first input/output 17a of the duplexer 17.

### 1-3-3 First Filter 7

The first filter 7 is a transmission filter having a first pass band that includes the first communication band (e.g., n77). The first filter 7 has an input 7a and an output 7b. The input 7a is connected to an output 13b of the power amplifier 13. The output 7b is connected to the selection terminal 6d of the first switch 6. The first filter 7 removes signal components in bands other than the first pass band from the transmission signal (first TDD signal) inputted to the input 7a (i.e., allows signal components in the same band as the first pass band to pass therethrough), and outputs the resulting transmission signal after removal of the signal components from the output 7b.

### 1-3-4 Duplexer 17

The duplexer 17 has the first input/output 17a, a second input/output 17b, and an output 17c. The first input/output 17a is connected to the selection terminal 6e of the first switch 6. The second input/output 17b is connected to a common terminal 10a of the second switch 10 via the variable matching network 11. The output 17c is connected to an input 16a of the low-noise amplifier 16.

The duplexer 17 includes the first filter 8 and the second filter 9.

The first filter 8 is a reception filter having a first pass band that includes the first communication band (e.g., n77). The first filter 8 has the same configuration as the first filter 7. The first filter 8 has an input and an output. The input of the first filter 8 is also used as the first input/output 17a and is connected to the selection terminal 6e of the first switch 6. The output of the first filter 8 is the output 17c, and is connected to the input 16a of the low-noise amplifier 16. Hereinafter, the input and output of the first filter 8 may be referred to as the input 17a and the output 17c, respectively. The first filter 8 removes signal components in bands other than the first pass band from a reception signal (first TDD signal) inputted to the input 17a (i.e., allows signal components in the same band as the first pass band to pass therethrough), and outputs the resulting reception signal after removal of the signal components from the output 17c.

The second filter 9 is a dual-purpose filter for transmission and reception and has a second pass band including the second communication band (e.g., n79). The second filter 9 has a first input/output and a second input/output. The first input/output of the second filter 9 is also used as the first input/output 17a and is connected to the selection terminal 6e of the first switch 6. The second input/output 17b of the second filter 9 is connected to the common terminal 10a of the second switch 10 via the variable matching network 11. Hereinafter, the first input/output and the second input/output of the second filter 9 may be respectively referred to as the first input/output 17a and the second input/output 17b.

The second filter 9 removes signal components in bands other than the second pass band from a reception signal (second TDD signal) inputted to the first input/output 17a (i.e., allows signal components in the same band as the second pass band to pass therethrough), and outputs the resulting reception signal after removal of the signal components from the second input/output 17b. The second filter 9 also removes signal components in bands other than the second pass band from a transmission signal (second TDD signal) inputted to the second input/output 17b (i.e., allows signal components in the same band as the second pass band to pass therethrough), and outputs the resulting transmission signal after removal of the signal components from the first input/output 17a.

The second filter 9 has attenuation bands on both sides of the second pass band. The attenuation band of the second filter 9 on the first pass band side (the pass band of the first filter 8) can be shifted toward the first pass band side or the second pass band side by changing the characteristic value (impedance) of the variable matching network 11, as will be described later.

### 1-3-5 Second Switch 10

The second switch 10 is a switch for selecting the connection destination of the second input/output 17b (second terminal) of the second filter 9 from among the power amplifier 14 (first power amplifier) and the low-noise amplifier 15 (first low-noise amplifier). In other words, the second switch 10 is a switch for switching transmission and reception of the second filter 9 via time division duplexing (TDD). The second switch 10 is controlled based on a control signal from a controller, which is not illustrated. The second switch 10 is, for example, a switch integrated circuit (IC).

The second switch 10 has the common terminal 10a and a plurality of (two in the example of FIG. 1) selection terminals 10b and 10c. The common terminal 10a is selectively connected to one of the two selection terminals 10b and 10c. The common terminal 10a is connected to the second input/output 17b of the second filter 9 via the variable matching network 11. The selection terminal 10b is connected to an output 14b of the power amplifier 14. The selection terminal 10c is connected to an input 15a of the low-noise amplifier 15.

### 1-3-6 Variable Matching Network 11

The variable matching network 11 is connected between the second filter 9 and the second switch 10, and performs impedance matching between the second filter 9 and the second switch 10. The variable matching network 11 is a matching network whose characteristic value (impedance) is variable. When the characteristic value is changed, the variable matching network 11 shifts the attenuation band of the second filter 9 on the first pass band side (i.e., the pass band of the first communication band) toward the first pass band side or the second pass band side (i.e., the pass band of the second filter 9). The characteristic value of the variable matching network 11 is changed by a predetermined controller in the radio-frequency module 1.

The first variable circuit element 12 is disposed inside the variable matching network 11. The first variable circuit element 12 is a circuit element whose characteristic value is variable, such as a variable capacitor, a variable inductor, or a variable resistor. Alternatively, the first variable circuit element 12 may be a circuit configured with a plurality of circuit elements including at least one variable circuit element whose characteristic value is variable. The characteristic value of the first variable circuit element 12 is a value that defines a characteristic related to the function of the circuit element, and is a capacitance value when the circuit element is a capacitor, an inductance value when the circuit element is an inductor, or a resistance value when the circuit element is a resistor. The characteristic value of the variable matching network 11 is changed by changing the characteristic value of the first variable circuit element 12. Therefore, the first variable circuit element 12 is a circuit element that shifts a first attenuation band of the second filter 9 on the first pass band side toward the first pass band side or the second pass band side.

More specifically, the characteristic value of the first variable circuit element 12 can be selected from, for example, two values (a first characteristic value and a second characteristic value). When the characteristic value of the first variable circuit element 12 is the first characteristic value, the first attenuation band of the second filter 9 is shifted toward the first pass band of the first communication band. When the characteristic value of the first variable circuit element 12 is the second characteristic value, the first attenuation band of the second filter 9 is shifted toward the second pass band of the second communication band.

### 1-3-7 Power Amplifiers 13 and 14

The power amplifier 13 amplifies a transmission signal (first TDD signal) in the first communication band. The power amplifier 13 has an input 13a and the output 13b. The input 13a of the power amplifier 13 is connected to the external terminal 5d. The output 13b of the power amplifier 13 is connected to the input 7a of the first filter 7. The power amplifier 13 amplifies the transmission signal inputted to the input 13a, and outputs the amplified transmission signal from the output 13b.

The power amplifier 14 amplifies a transmission signal (second TDD signal) in the second communication band. The power amplifier 14 has an input 14a and the output 14b. The input 14a of the power amplifier 14 is connected to the external terminal 5e. The output 14b of the power amplifier 14 is connected to the selection terminal 10b of the second switch 10. The power amplifier 14 amplifies the transmission signal inputted to the input 14a and outputs the amplified transmission signal from the output 14b.

### 1-3-8 Low-Noise Amplifiers 15 and 16

The low-noise amplifier 15 amplifies a reception signal (second TDD signal) in the second communication band. The low-noise amplifier 15 has the input 15a and an output 15b. The input 15a of the low-noise amplifier 15 is connected to the selection terminal 10c of the second switch 10. The output 15b of the low-noise amplifier 15 is connected to the external terminal 5f. The low-noise amplifier 15 amplifies the reception signal inputted to the input 15a and outputs the amplified reception signal from the output 15b.

The low-noise amplifier 16 amplifies a reception signal (first TDD signal) in the first communication band. The low-noise amplifier 16 has the input 16a and an output 16b. The input 16a of the low-noise amplifier 16 is connected to the output 17c of the first filter 8. The output 16b of the low-noise amplifier 16 is connected to the external terminal 5g. The low-noise amplifier 16 amplifies the reception signal inputted to the input 16a, and outputs the amplified reception signal from the output 16b.

### 1-4 Details of Frequency Characteristic of Second Filter

A frequency characteristics M2 of the second filter 9 will be described with reference to FIG. 2.

In Embodiment 1, the second pass band 91 of the second filter 9 is located further toward the high frequency side than the first pass band 71 of the first filter 7.

First, a frequency characteristic M11 of the first filter 7 will be described. The frequency characteristic M11 of the first filter 7 includes the first pass band 71, a first transition band 72, and a first attenuation band 73. The first pass band 71 is a frequency band that includes the first communication band (e.g., n77). The first transition band 72 is a transition band on the second pass band 91 side of the first pass band 71, and is located on the second pass band 91 side of the first pass band 71. A first boundary frequency K1 defines the boundary between the first pass band 71 and the first transition band 72. The first attenuation band 73 is an attenuation band on the second pass band 91 side of the first pass band 71, and is located on the second pass band 91 side of the first transition band 72.

Next, the frequency characteristic M2 of the second filter 9 will be described. The frequency characteristic M2 of the second filter 9 includes the second pass band 91, a second transition band 92, and the second attenuation band 93. The second pass band 91 is a frequency band that includes the second communication band (e.g., n79). The second transition band 92 is a transition band on the first pass band 71 side of the second pass band 91, and is located on the first pass band 71 side of the second pass band 91. A second boundary frequency K2 defines the boundary between the second pass band 91 and the second transition band 92. The second attenuation band 93 is an attenuation band on the first pass band 71 side of the first pass bands 71 and 81, and is located on the first pass band 71 side of the second transition band 92.

In Embodiment 1, the first communication band (e.g., n77) and the second communication band (e.g., n79) are adjacent to each other, and therefore a band K3 between the first pass band 71 of the first filter 7 and the second pass band 91 of the second filter 9 is relatively narrow. Therefore, within the band K3, the first transition band 72 of the first filter 7 and the second transition band 92 of the second filter 9 overlap each other.

The frequency characteristic M2 of the second filter 9 is the frequency characteristic of the second filter 9 when the characteristic value of the first variable circuit element 12 is the first characteristic value. A frequency characteristic M2a in FIG. 2 is the frequency characteristic of the second filter 9 when the characteristic value of the first variable circuit element 12 is the second characteristic value.

The frequency characteristic M2a of the second filter 9 is a frequency characteristic obtained by shifting the frequency characteristic M2 of the second filter 9 toward the second pass band 91. More specifically, the frequency characteristic M2a of the second filter 9 includes a second pass band 91a, a second transition band 92a, and a second attenuation band 93a.

The second pass band 91a is a frequency band that includes the second communication band. The second transition band 92a is a transition band on the first pass band 71 side of the second pass band 91a, and is located on the first pass band 71 side of the second pass band 91a. The second attenuation band 93a is an attenuation band on the first pass band 71 side of the second pass band 91a, and is located on the first pass band 71 side of the second transition band 92a.

The frequency characteristic M2a of the second filter 9 after the band shift is shifted toward the second pass band 91 compared to the frequency characteristic M2 before the band shift. Therefore, the second transition band 92a after the band shift is shifted toward the second pass band 91 compared to the second transition band 92 before the band shift, and the second attenuation band 93a after the band shift is shifted toward the second pass band 91 (higher frequency side) compared to the second attenuation band 93 before the band shift. Therefore, the second transition band 92a after the band shift overlaps the first transition band 72 of the first filter 7 within the band K3 to a lesser extent compared to the second transition band 92 before the band shift. As a result, the frequency characteristic M2a after the band shift has less interference with the frequency characteristic M11 of the first filter 7 within the band K3 compared to the frequency characteristic M2 before the band shift.

Furthermore, the second transition band 92a after the band shift is shifted toward the second pass band 91 (higher frequency side) relative to the second boundary frequency K2. As a result, the second pass band 91a after the band shift is narrower than the second pass band 91 before the band shift. As a result, there is increased pass loss (also referred to as insertion loss) when a TDD signal passes through the second filter 9 in the frequency characteristic M2a after the band shift compared to the frequency characteristic M2 before the band shift.

In other words, there is increased interference with the frequency characteristic M11 of the first filter 7 within the band K3 in the frequency characteristic M2 of the second filter 9 before the band shift compared to the frequency characteristic M2a after the band shift. In addition, there is decreased pass loss (also called insertion loss) when the second TDD signal passes through the second filter 9 in the frequency characteristic M2 before the band shift compared to the frequency characteristic M2a after the band shift.

That is, in Embodiment 1, when the characteristic value of the first variable circuit element 12 is the first characteristic value, the second attenuation band 93 of the second filter 9 on the first pass band 71 side is shifted toward the first pass band 71. In this case, the insertion loss of the second filter 9 decreases and interference with the first filter 7 increases. On the other hand, when the characteristic value of the first variable circuit element 12 is the second characteristic value, the second attenuation band 93 on the first pass band 71 side of the second filter 9 is shifted toward the second pass band 91. In this case, the insertion loss of the second filter 9 is increased and interference with the first filter 7 is decreased.

In Embodiment 1, the frequency characteristic M2a of the second filter 9 after the band shift is formed by, for example, combining the frequency characteristic M2 before the band shift with a frequency characteristic Q1 of a resonant circuit, which is not illustrated. The resonant circuit is a resonant circuit that attenuates a specific frequency (resonant frequency), such as a notch filter. A peak frequency (resonant frequency) fp of the frequency characteristic Q1 of the resonant circuit is set between a null point N2 of the frequency characteristic M2 of the second filter 9 and the second pass band 91.

That is, the first variable circuit element 12 includes a resonant circuit, and when the characteristic value of the first variable circuit element 12 is the first characteristic value, the resonant circuit is disabled, resulting in no change in the frequency characteristic M2 of the second filter 9. On the other hand, when the characteristic value of the first variable circuit element 12 is the second characteristic value, the resonant circuit is enabled, resulting in the frequency characteristic M2 before the change and the frequency characteristic Q1 of the resonant circuit being combined, and the frequency characteristic M2 of the second filter 9 changing to the frequency characteristic M2a.

The notch filter is an example of a resonant circuit that attenuates a specific frequency (for example, a specific frequency between the null point N2 and the second pass band 91).

In the above description, the frequency characteristic M2 of the second filter 9 has been described based on the relationship between the frequency characteristic M2 of the second filter 9 and the frequency characteristic M11 of the first filter 7. As described above, the two first filters 7 and 8 have the same configuration. Therefore, a frequency characteristic M12 of the first filter 8 is the same as the frequency characteristic M11 of the first filter 7. That is, the frequency characteristic M12 of the first filter 8 includes a first pass band 81, a first transition band 82, and a first attenuation band 83. The first pass band 81, the first transition band 82, and the first attenuation band 83 of the first filter 8 are the same as the first pass band 71, the first transition band 72, and the first attenuation band 73 of the first filter 7, respectively. That is, when the characteristic value of the first variable circuit element 12 is the first characteristic value, the second attenuation band 93 on the first pass band 81 side of the second filter 9 is shifted toward the first pass band 81. In this case, the second filter 9 has reduced insertion loss and increased band interference with the first filter 8. On the other hand, when the characteristic value of the first variable circuit element 12 is the second characteristic value, the second attenuation band 93 of the second filter 9 on the first pass band 81 side is shifted toward the second pass band 91. In this case, the second filter 9 has increased insertion loss and reduced band interference with the first filter 8.

### 1-5 Operation of Radio-Frequency Module 1

The operation of the radio-frequency module 1 will be described with reference to FIG. 1.

### 1-5-1 Operation When Communication is Solely Performed in Second Communication Band

The operation when reception is solely performed in the second communication band (first case) will be described. In the first case, for example, in the first switch 6, the common terminal 6b is connected to the selection terminal 6e, and the remaining common terminals 6a and 6c are not connected to the selection terminals 6d and 6e. In addition, in the second switch 10, the common terminal 10a is connected to the selection terminal 10c. The characteristic value of the first variable circuit element 12 is set to the first characteristic value, and the frequency characteristic M2 (see FIG. 2) of the second filter 9 is maintained at the frequency characteristic M2. In this state, when the antenna 3 receives the second TDD signal as a reception signal, the reception signal is outputted from the external terminal 5f to the signal processing circuit 2 via the first switch, the second filter 9, the variable matching network 11, the second switch 10, and the low-noise amplifier 15. At this time, because the frequency characteristic M2 of the second filter 9 is maintained at the frequency characteristic M2, the insertion loss when the reception signal, i.e., the second TDD signal, passes through the second filter 9 is reduced, particularly the loss of the reception signal in the second transition band 92a. That is, the communication quality during communication of the second TDD signal alone can be improved.

When transmission is performed solely using the second communication band, the characteristic value of the first variable circuit element 12 is set to the first characteristic value, and the frequency characteristic M2 of the second filter 9 is maintained at the frequency characteristic M2, as with the first case above. Therefore, the insertion loss when the transmission signal, i.e., the second TDD signal, passes through the second filter 9 is reduced, as with the above case, and the loss of the transmission signal in the second transition band 92a in particular can be reduced.

### 1-5-2 Operation When Performing Communication Simultaneously in First Communication Band and Second Communication Band

The operation when transmission using the first communication band and reception using the second communication band are performed simultaneously (second case) will be described. In the first switch 6, for example, the common terminal 6a is connected to the selection terminal 6d, the common terminal 6b is connected to the selection terminal 6e, and the remaining common terminal 6c is not connected to the selection terminal 6d or 6e. In addition, in the second switch 10, the common terminal 10a is connected to the selection terminal 10c. In addition, the characteristic value of the first variable circuit element 12 is set to the second characteristic value, and the frequency characteristic M2 of the second filter 9 is changed to the frequency characteristic M2a (see FIG. 2).

In this state, when the antenna 3 receives a reception signal, which is the second TDD signal, the reception signal passes through the first switch 6, the second filter 9, the variable matching network 11, the second switch 10, and the low-noise amplifier 15 and is outputted from the external terminal 5f to the signal processing circuit 2. Simultaneously with this reception operation, a transmission signal, which is the first TDD signal, is inputted from the signal processing circuit 2 to the external terminal 5d. The transmission signal is then transmitted from the antenna 3 to the outside via the external terminal 5d, the power amplifier 13, the first filter 7, and the first switch 6.

At this time, a portion of the transmission signal that is the first TDD signal leaks from the selection terminal 6e of the first switch 6 to the second filter 9. However, as described above, by setting the characteristic value of the first variable circuit element 12 to the second characteristic value, the frequency characteristic M2 of the second filter 9 is changed to the frequency characteristic M2a (see FIG. 2). This reduces interference between signals passing through the band between the frequency characteristic M2a of the second filter 9 and the frequency characteristic M11 of the first filter 7 (first transition band 72 and second transition band 92). This reduces the portion of the transmission signal, which is the first TDD signal, that passes through the second filter 9. As a result, it is possible to reduce the interference between the reception signal, which is the second TDD signal, and the transmission signal, which is the first TDD signal, that have passed through the second filter 9. In other words, it is possible to reduce the deterioration in reception sensitivity when receiving the second TDD signal, thereby improving communication quality.

When reception using the first communication band and transmission using the second communication band are performed simultaneously, the first filter 8 is used as a reception filter and the second filter 9 is used as a transmission filter. In this case, as with the second case, the characteristic value of the first variable circuit element 12 is set to the second characteristic value, and the frequency characteristic M2 of the second filter 9 is changed to the frequency characteristic M2a. That is, the interference between the transmission signal of the second communication band passing through the second transition band 92 of the second filter 9 and the reception signal of the first communication band passing through the first transition band 82 of the first filter 8 is reduced. Therefore, the passage of a portion of the transmission signal of the second communication band through the second filter 9 can be reduced. As a result, a situation in which the transmission signal of the second communication band passes through the second filter 9 and enters the reception path of the first communication band can be reduced. That is, it is possible to reduce the deterioration of reception sensitivity during reception in the first communication band, thereby improving communication quality.

### 1-6 Effects

The radio-frequency module 1 according to Embodiment 1 processes a first TDD signal in a first communication band and a second TDD signal in a second communication band adjacent to the first communication band. The communication band of the first communication band is wider than the communication band of the second communication band. The radio-frequency module 1 includes the first filters 7 and 8, the second filter 9, the first switch 6, the second switch 10, and the first variable circuit element 12. The first filters 7 and 8 have the first pass bands 71 and 81 that include the first communication band. The second filter 9 has the second pass band 91 that includes the second communication band. The first switch 6 selects the connection destination of each of a plurality of antenna terminals 5a to 5c from among first terminals 7b and 17a of the first filters 7 and 8 and the second filter 9. The second switch 10 selects the connection destination of the second terminal 17b of the second filter 9 from among the first power amplifier 14 and the first low-noise amplifier 15. The first variable circuit element 12 is connected inside the second filter 9, inside the second switch 10, or between the second filter 9 and the second switch 10, and shifts the second attenuation band 93, which is on the side near the first pass bands 71 and 81, in the second filter 9.

According to this configuration, by using the first variable circuit element 12 to shift the second attenuation band 93, which is on the side near the first pass bands 71 and 81, in the second filter 9, it is possible to reduce the interference between signals of the adjacent first and second communication bands and reduce the deterioration of communication quality.

More specifically, when transmission using the first communication band and reception using the second communication band are performed simultaneously, or when reception using the first communication band and transmission using the second communication band are performed simultaneously, the second attenuation band 93, which is on the side near the first pass band 71 and 81, in the second filter 9 is shifted toward the second pass band 91 by the first variable circuit element 12. In this way, leakage of the transmission signal of the first communication band or the second communication band into the reception path can be reduced. As a result, the signal interference between the first communication band and the second communication band can be reduced. Furthermore, when communication using the first communication band or communication using the second communication band is solely performed, the first variable circuit element 12 is not varied, and the filter characteristics are maintained. This allows insertion loss when the second TDD signal passes through the second filter 9 to be reduced. As a result, the deterioration of communication quality in the first communication band and the second communication band can be reduced.

Moreover, the radio-frequency module 1 according to Embodiment 1 further includes the variable matching network 11. The variable matching network 11 is connected between the second filter 9 and the second switch 10. The first variable circuit element 12 is disposed inside the variable matching network 11.

With this configuration, the number of components can be reduced, and there is no need to secure a new location for the first variable circuit element 12.

The communication device 200 according to Embodiment 1 includes the radio-frequency module 1 and the signal processing circuit 2. The signal processing circuit 2 is connected to the radio-frequency module 1 and performs signal processing on radio-frequency signals.

With this configuration, the communication device 200 that exhibits the effects of the radio-frequency module 1 can be provided.

### 1-7 Modifications

A modification of Embodiment 1 will be described. In Embodiment 1, the first variable circuit element 12 is disposed inside the variable matching network 11. However, the first variable circuit element 12 is not limited to being disposed inside the variable matching network 11, and may be disposed inside the second filter 9, inside the second switch 10, or between the second filter 9 and the second switch 10. When the first variable circuit element 12 is disposed inside the second filter 9, the first variable circuit element 12 may be configured by replacing one of the plurality of circuit components (capacitors, inductors, and inductors) included in the second filter 9 with a variable circuit component whose characteristic value is variable. With this modification as well, the same effects as Embodiment 1 can be achieved.

### 2 Embodiment 2

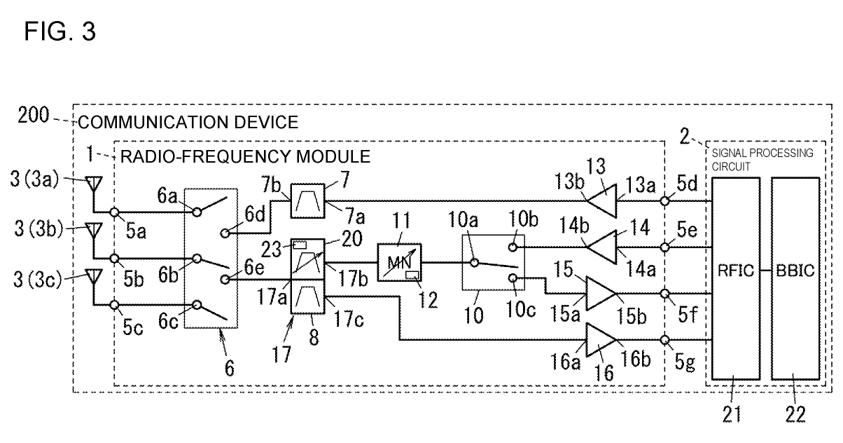

A radio-frequency module 1 according to Embodiment 2 will be described with reference to FIG. 3.

### 2-1 Configuration

The radio-frequency module 1 according to Embodiment 2 differs from the radio-frequency module 1 according to Embodiment 1 in that the radio-frequency module 1 according to Embodiment 2 includes a second filter 20, which is a variable filter, instead of the second filter 9. The following description will focus on components that are different from the First Embodiment 1, with the same reference numerals being used to denote the same components as those in the First Embodiment 1.

The second filter 20 is a variable filter obtained by replacing at least one of the circuit elements included in the second filter 9 of Embodiment 1 with a variable circuit element (second variable circuit element 23). That is, the second filter 20 includes the second variable circuit element 23.

The second variable circuit element 23 is, for example, a variable capacitor, a variable inductor, or a variable resistor.

The frequency characteristics of the second filter 20 are changed by changing the characteristic value of the second variable circuit element 23. The characteristic value of the second filter 20 is changed by changing the characteristic value of the second variable circuit element 23. The characteristic value of the second variable circuit element 23 is controlled by a controller, which is not illustrated.

As with the second filter 9 of Embodiment 1, the second filter 20 has a second pass band, a second transition band, and a second attenuation band. The second pass band includes a second communication band. The second transition band is a transition band on the first pass band (pass band of the first filter 7) side of the second pass band. The second attenuation band is an attenuation band on the first pass band (pass band of the first filter 7) side of the second pass band. The second filter 20 is configured such that one or two of the second pass band, the second transition band, and the second attenuation band of the second filter 20 is selectively moved closer to or further away from the first pass band of the first filter 7 by changing the characteristic value of the second variable circuit element 23.

More specifically, the frequency characteristic of the second filter 20 is shifted toward the first pass band or the second pass band by changing the characteristic value of the first variable circuit element 12, as with the frequency characteristic of the second filter 9 of Embodiment 1. At this time, the frequency characteristic of the second filter 20 is finely tuned by selectively shifting the second pass band, the second transition band, or the second attenuation band of the second filter 20 by changing the characteristic value of the second variable circuit element 23.

More specifically, when communication (e.g., reception) is performed solely using the second communication band, when the characteristic value of the first variable circuit element 12 is set to the first characteristic value, the frequency characteristic of the second filter 20 as a whole (i.e., all of the second pass band, the second transition band, and the second attenuation band) is shifted toward the first pass band, as with the frequency characteristic M2 of the second filter 9 of Embodiment 1 (see FIG. 2). In this case, additionally, by changing the characteristic value of the second variable circuit element 23, the second pass band of the second filter 20 is not shifted, and only the second attenuation band and the second transition band of the second filter 20 are selectively shifted toward the second pass band (i.e., returned). As a result, in the frequency characteristic of the second filter 20, only the second pass band is shifted toward the first pass band, as indicated by the second pass band 91 in FIG. 2, while the second transition band and the second attenuation band are maintained as shifted toward the second pass band, as indicated by the second transition band 92a and the second attenuation band 93a in FIG. 2. As a result, when communication (for example, reception) is solely performed in the second communication band, it is possible to reduce the insertion loss when the second TDD signal (reception) passes through the second filter 20, as in the first case in the description of the operation in Embodiment 1. Furthermore, it is possible to reduce the interference between unwanted signals and the reception signal, which is the second TDD signal, thereby improving communication quality.

Furthermore, when communication using the first communication band (e.g., transmission) and communication using the second communication band (e.g., reception) are performed simultaneously, when the characteristic value of the first variable circuit element 12 is set to the second characteristic value, the frequency characteristic of the second filter 20 as a whole (i.e., all of the second pass band, the second transition band, and the second attenuation band) is shifted toward the second pass band, as with the frequency characteristic M2a of the second filter 9 of Embodiment 1 (see FIG. 2). In this case, additionally, by changing the characteristic value of the second variable circuit element 23, the second transition band and second attenuation band of the second filter 20 are not shifted, and only the second pass band of the second filter 20 is selectively shifted toward the first pass band (i.e., returned). As a result, in the frequency characteristic of the second filter 20, only the second transition band and the second attenuation band are shifted toward the first pass band, as indicated by the second transition band 92a and the second attenuation band 93a in FIG. 2, and the second pass band is maintained as shifted toward the first pass band, as indicated by the second pass band 91 in FIG. 2. As a result, when communication using the first communication band (e.g., transmission) and communication using the second communication band (e.g., reception) are performed simultaneously, as in the second case of the description of the operation in Embodiment 1, it is possible to reduce mixing of a portion of the first TDD signal (transmission signal) with the second TDD signal (reception signal) when the second TDD signal passes through the second filter 20. Furthermore, it is possible to reduce insertion loss when the second TDD signal (reception signal) passes through the second filter 20.

### 2-2 Effects

The radio-frequency module 1 according to Embodiment 2 further includes the second variable circuit element 23. The second variable circuit element 23 constitutes a variable circuit element included in the second filter 20, which is a variable filter. With this configuration, since the first variable circuit element 12 and the second variable circuit element 23 are included, the interference between the adjacent first and second communication bands can be further reduced, and the deterioration of communication quality can be further reduced.

### 3 Embodiment 3

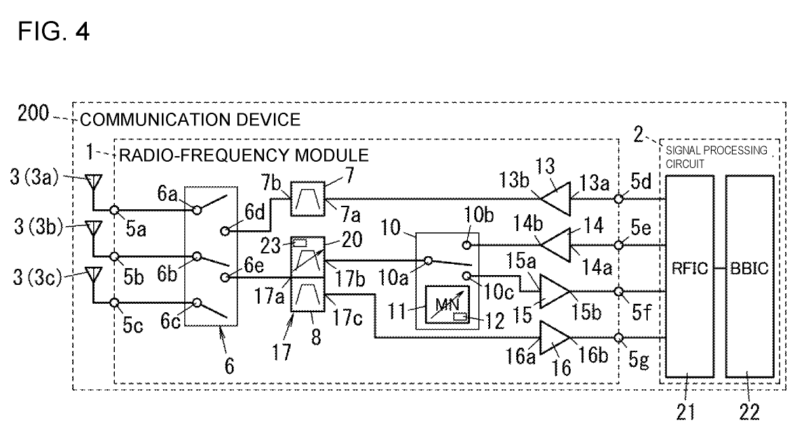

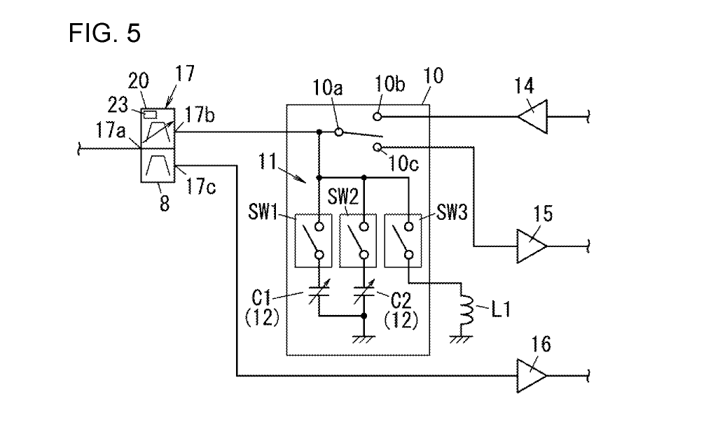

A radio-frequency module 1 according to Embodiment 3 will be described with reference to FIGS. 4 and 5.

### 3-1 Configuration

As illustrated in FIG. 4, the radio-frequency module 1 according to Embodiment 3 is configured in substantially the same manner as the radio-frequency module 1 according to Embodiment 2, except that the variable matching network 11 and the first variable circuit element 12 are disposed inside the second switch 10.

As illustrated in FIG. 5, the second switch 10 has substantially the same configuration as the second switch 10 of Embodiment 2, except that the second switch 10 of this embodiment includes the variable matching network 11 and the first variable circuit element 12.

The variable matching network 11 includes variable capacitors C1 and C2, an inductor L1, and switches SW1 to SW3.

The variable capacitors C1 and C2 each constitute a first variable circuit element 12. That is, in Embodiment 2, the variable matching network 11 includes two first variable circuit elements 12 (variable capacitors C1 and C2).

The variable capacitor C1 has a first terminal and a second terminal. The first terminal of the variable capacitor C1 is connected to the common terminal 10a of the second switch 10 via the switch SW1. The second terminal of the variable capacitor C1 is connected to ground. The variable capacitor C2 has a first terminal and a second terminal. The first terminal of the variable capacitor C2 is connected to the common terminal 10a of the second switch 10 via the switch SW2. The second terminal of the variable capacitor C2 is connected to ground. The inductor L1 has a first terminal and a second terminal. The first terminal of the inductor L1 is connected to the common terminal 10a of the second switch 10 via the switch SW3. The second terminal of the inductor L1 is connected to ground.

In Embodiment 3, the variable capacitors C1 and C2 and the switches SW1 to SW3 are disposed inside the second switch 10, and the inductor L1 is disposed outside the second switch 10. However, the inductor L1 may also be disposed inside the second switch 10.

The variable capacitors C1 and C2 and the inductor L1 constitute a resonant circuit that attenuates a specific frequency (resonant frequency). By changing the characteristic values (capacitance values) of the variable capacitors C1 and C2, the resonant frequency can be changed and the resonant circuit can be enabled or disabled. The resonant circuit can also be enabled or disabled by switching the switches SW1 to SW3 on or off.

For example, when the resonant circuit is enabled and a predetermined frequency is attenuated by the resonant circuit, the switches SW1 to SW3 are turned on and the capacitance values of the variable capacitors C1 and C2 are changed to predetermined values. On the other hand, when the resonant circuit is disabled, all of the switches SW1 to SW3 may be turned off, or the capacitance values of the variable capacitors C1 and C2 may be changed to predetermined values (sufficiently large or small).

### 3-2 Effects

In the radio-frequency module 1 according to Embodiment 3, the variable matching network 11 and the first variable circuit element 12 are disposed inside the second switch 10. This eliminates the need to secure additional space in which the variable matching network 11 and the first variable circuit element 12 are disposed. Furthermore, the radio-frequency module 1 can be reduced in size.

### 4 Embodiment 4

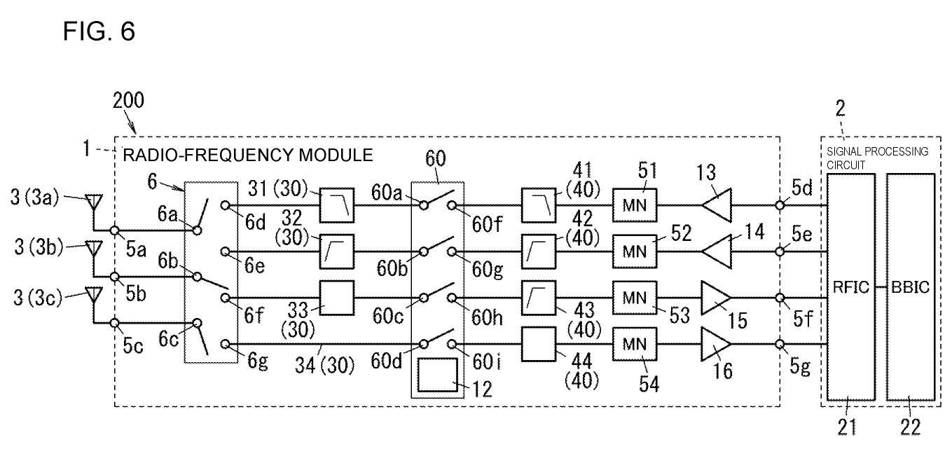

A radio-frequency module 1 according to Embodiment 4 will be described with reference to FIG. 6.

### 4-1 Configuration

As illustrated in FIG. 6, the radio-frequency module 1 according to Embodiment 4 differs from the radio-frequency module 1 according to Embodiment 3 in that the first filters 7 and 8, the second filter 20, the second switch 10, and the second variable circuit element 23 are omitted, and the radio-frequency module 1 according to Embodiment 4 further includes a plurality of third filters 30 (only four are illustrated in the example in FIG. 6), a plurality of fourth filters 40 (only four are illustrated in the example in FIG. 6), a second switch 60, and a plurality of matching networks 51 to 54 (four in the example in FIG. 6).

In Embodiment 4, the first filters 7 and 8 or the second filter 20 of Embodiment 2 are configured using one of the third filters selected from among the plurality of third filters 30 and one of the fourth filters selected from among the plurality of fourth filters 40.

The radio-frequency module 1 according to Embodiment 4 includes a plurality of external terminals 5a to 5g, a first switch 6, a second switch 60, a plurality of third filters 30, a plurality of fourth filters 40, a plurality of matching networks 51 to 54, a plurality of (two in the example in FIG. 6) power amplifiers 13 and 14, and a plurality of (two in the example in FIG. 6) low-noise amplifiers 15 and 16.

The external terminals 5a to 5g are the same as the external terminals 5a to 5g in Embodiment 3, and therefore detailed description thereof is omitted.

The first switch 6 has substantially the same configuration as the first switch 6 of Embodiment 3, except that the number of selection terminals is increased. More specifically, the first switch 6 has a plurality of (three in the example in FIG. 6) common terminals 6a to 6c and a plurality of (four in the example in FIG. 6) selection terminals 6d to 6g. Each of the plurality of common terminals 6a to 6c is selectively connected to one of the plurality of selection terminals 6d to 6g.

The plurality of common terminals 6a to 6c are respectively connected to the plurality of external terminals 5a to 5c. The selection terminal 6d is connected to the common terminal 10a of the second switch 60 via a low-pass filter 31. The selection terminal 6e is connected to a common terminal 60b of the second switch 60 via a high-pass filter 32. The selection terminal 6f is connected to a common terminal 60c of the second switch 60 via a notch filter 33. The selection terminal 6g is connected to a common terminal 60d of the second switch 60 via a signal path 34.

The plurality of third filters 30 includes one or more low-pass filters 31 (one in the example in FIG. 6) having different characteristics from each other, and one or more high-pass filters 32 (one in the example in FIG. 6) having different characteristics from each other. Although only three third filters 31 to 33 are illustrated in FIG. 6 as the plurality of third filters 30, in reality, third filters other than the three third filters 31 to 33 may also be included.

The low-pass filter 31 is a low-pass filter corresponding to the second communication band (e.g., n79). The low-pass filter 31 has a pass band, a high-frequency-side transition band, and a high-frequency-side attenuation band. The low-pass filter 31 is a low pass filter that prioritizes attenuation in which, for example, the high-frequency-side transition band is close to the upper limit frequency of the first communication band, thereby widening the high-frequency-side attenuation band on the pass band side.

The low-pass filter 31 has a first terminal and a second terminal. The first terminal of the low-pass filter 31 is connected to the selection terminal 6d of the first switch 6. The second terminal of the low-pass filter 31 is connected to a common terminal 60a of the second switch 60. The low-pass filter 31 removes high-frequency components higher than the pass band from a signal inputted to one of the first terminal and the second terminal, and outputs the signal after removal of the high-frequency components from the other of the first terminal and the second terminal.

The high-pass filter 32 is a high-pass filter corresponding to the first communication band (e.g., n77). The high-pass filter 32 has a pass band, a low-frequency-side transition band, and a low-frequency-side attenuation band. The high-pass filter 32 is a high pass filter that prioritizes attenuation in which, for example, the low-frequency-side transition band is close to the lower limit frequency of the second communication band, and the low-frequency-side attenuation band is widened on the pass band side.

The high-pass filter 32 has a first terminal and a second terminal. The first terminal of the high-pass filter 32 is connected to the selection terminal 6e of the first switch 6. The second terminal of the high-pass filter 32 is connected to the common terminal 60b of the second switch 60. The high-pass filter 32 removes low-frequency components lower than the pass band from a signal inputted to one of the first terminal and the second terminal, and outputs the signal after removal of the low-frequency components from the other of the first terminal and the second terminal.

The notch filter 33 is a filter that reduces a specific frequency and is configured, for example, by a resonant circuit. The notch filter 33 is connected between the selection terminal 6f of the first switch 6 and the common terminal 60c of the second switch 60. When used in combination with the high-pass filter 42 or 43, for example, the notch filter 33 is a filter for further widening the attenuation band on the low frequency side of the high-pass filter 42 or 43 toward the pass band side (high frequency side) of the high-pass filter 42 or 43.

The signal path 34 is connected between the selection terminal 6g of the first switch 6 and the common terminal 60d of the second switch 60. The signal path 34 can be interpreted as a filter with an infinite pass band. The signal path 34 is a path to be selected when it is not desired to select any of the plurality of third filters 31 to 33.

The second switch 60 selects from among the plurality of fourth filters 40 a connection partner for one of the plurality of third filters 30 selected by the first switch 6. The second switch 60 has a plurality of (four in the example of FIG. 6) common terminals 60a to 60d and a plurality of (four in the example of FIG. 6) selection terminals 60f to 60i. The plurality of common terminals 60a to 60d are selectively connected to one of the plurality of selection terminals 60f to 60i. The common terminal 60a is connected to the selection terminal 6d of the first switch 6 via the low-pass filter 31. The common terminal 60b is connected to the selection terminal 6e of the first switch 6 via the high-pass filter 32. The common terminal 60c is connected to the selection terminal 6f of the first switch 6 via the notch filter 33. The common terminal 60d is connected to the selection terminal 6g of the first switch 6 via the signal path 34.

The first variable circuit element 12 is disposed inside the second switch 60. The second variable circuit element 23 is connected to the common terminal 60a. As in Embodiment 3, the second variable circuit element 23 shifts the frequency characteristics of second filters used for transmission and reception, which will be described later.

The plurality of fourth filters 40 include one or more (two in the example of FIG. 6) low-pass filters 41 and 44 having different characteristics from each other, and one or more (one in the example of FIG. 6) high-pass filters 42 and 43 having different characteristics from each other.

The low-pass filter 41 is a low-pass filter corresponding to the first communication band (e.g., n77). The low-pass filter 41 has a pass band, a high-frequency-side transition band, and a high-frequency-side attenuation band. The low-pass filter 41 is a low-pass filter that prioritizes low insertion loss, with the pass band widened toward the high-frequency side due to, for example, the high-frequency-side transition band being spaced a certain distance toward the high-frequency side from the upper limit frequency of the first communication band.

The low-pass filter 41 has a first terminal and a second terminal. The first terminal of the low-pass filter 41 is connected to the selection terminal 60f of the second switch 60. The second terminal of the low-pass filter 41 is connected to the output of the power amplifier 13 via the matching network 51. The low-pass filter 41 removes high-frequency components higher than the pass band from the signal inputted to the first terminal, and outputs the signal after removal of the high frequency components from the second terminal.

The high-pass filter 42 is a high-pass filter corresponding to the second communication band (e.g., n79). The high-pass filter 42 has a pass band, a low-frequency-side transition band, and a low-frequency-side attenuation band. The high-pass filter 42 is a high-pass filter that prioritizes low insertion loss, with the pass band widened toward the low-frequency side by, for example, the low-frequency-side transition band being spaced a certain distance toward the lower frequency side from the lower limit frequency of the second communication band.

The high-pass filter 42 has a first terminal and a second terminal. The first terminal of the high-pass filter 42 is connected to the selection terminal 60g of the second switch 60. The second terminal of the high-pass filter 42 is connected to the output of the power amplifier 14 via the matching network 52. The high-pass filter 42 removes low-frequency components lower than the pass band from the signal inputted to the second terminal, and outputs the signal after removal of the low-frequency components from the first terminal.

The high-pass filter 43 is a high-pass filter corresponding to the second communication band (e.g., n79). The high-pass filter 43 has a pass band, a low-frequency-side transition band, and a low-frequency-side attenuation band. The high-pass filter 43 is a high-pass filter that prioritizes low insertion loss, with the pass band widened toward the low-frequency side due to, for example, the low-frequency-side transition band being spaced a certain distance toward the lower frequency side from the lower limit frequency of the second communication band.

The pass band of the high-pass filter 43 is wider (or narrower) than the pass band of the high-pass filter 42, and therefore the high-pass filter 43 and the high-pass filter 42 have different characteristics.

The high-pass filter 43 has a first terminal and a second terminal. The first terminal of the high-pass filter 43 is connected to the selection terminal 60h of the second switch 60. The second terminal of the high-pass filter 43 is connected to the input of the low-noise amplifier 15 via the matching network 53. The high-pass filter 43 removes low-frequency components lower than the pass band from the signal inputted to the second terminal, and outputs the signal after removal of the low-frequency components from the first terminal.

The low-pass filter 44 is a low-pass filter corresponding to a first communication band (e.g., n77). The low-pass filter 41 has a pass band, a high-frequency-side transition band, and a high-frequency-side attenuation band. The low-pass filter 41 is a low-pass filter that prioritizes low insertion loss, with the pass band widened toward the high-frequency side due to, for example, the high-frequency-side transition band being spaced a certain distance toward the high-frequency side from the upper limit frequency of the first communication band.

The pass band of the low-pass filter 44 is wider (or narrower) than the pass band of the low-pass filter 41, and therefore the low-pass filter 44 and the low-pass filter 41 have different characteristics.

The low-pass filter 44 has a first terminal and a second terminal. The first terminal of the low-pass filter 44 is connected to the selection terminal 60i of the second switch 60. The second terminal of the low-pass filter 44 is connected to the input of the low-noise amplifier 16 via the matching network 54. The low-pass filter 44 removes high-frequency components higher than the pass band from the signal inputted to the first terminal, and outputs the signal after removal of the high frequency components from the second terminal.

The matching network 51 is connected between the low-pass filter 41 and the power amplifier 13 and performs impedance matching between the low-pass filter 41 and the power amplifier 13. The matching network 52 is connected between the high-pass filter 42 and the power amplifier 14 and performs impedance matching between the high-pass filter 42 and the power amplifier 14. The matching network 53 is connected between the high-pass filter 43 and the low-noise amplifier 15 and performs impedance matching between the high-pass filter 43 and the low-noise amplifier 15. The matching network 54 is connected between the low-pass filter 44 and the low-noise amplifier 16 and performs impedance matching between the low-pass filter 41 and the low-noise amplifier 16.

The plurality of power amplifiers 13 and 14 have a one-to-one correspondence with two predetermined fourth filters 41 and 42 among the plurality of fourth filters 40. In addition, the plurality of low-noise amplifiers 15 and 16 have a one-to-one correspondence with two predetermined fourth filters 43 and 44 among the plurality of fourth filters 40.

The power amplifier 13 has substantially the same configuration as the power amplifier 13 of Embodiment 3. The power amplifier 13 has an input and an output. The input of the power amplifier 13 is connected to the external terminal 5d. The output of the power amplifier 13 is connected to a second terminal of the corresponding low-pass filter 41 via the matching network 51.

The power amplifier 14 has substantially the same configuration as the power amplifier 14 of Embodiment 3. The power amplifier 14 has an input and an output. The input of the power amplifier 14 is connected to the external terminal 5e. The output of the power amplifier 14 is connected to a second terminal of the corresponding high-pass filter 43 via the matching network 52.

The low-noise amplifier 15 has substantially the same configuration as the low-noise amplifier 15 of Embodiment 3. The low-noise amplifier 15 has an input and an output. The input of the low-noise amplifier 15 is connected to a second terminal of the corresponding high-pass filter 43 via the matching network 53. The output of the low-noise amplifier 15 is connected to the external terminal 5f.

The low-noise amplifier 16 has substantially the same configuration as the low-noise amplifier 16 of Embodiment 3. The low-noise amplifier 16 has an input and an output. The input of the low-noise amplifier 16 is connected to a second terminal of the corresponding low-pass filter 44 via the matching network 54. The output of the low-noise amplifier 16 is connected to the external terminal 5g.

In Embodiment 4, a second filter for transmission having a pass band including the second communication band (e.g., n79) is formed by using the low-pass filter 31 and the high-pass filter 42 in combination with each other. In addition, a second filter for reception having a pass band including the second communication band (e.g., n79) is formed by using the low-pass filter 31 and the high-pass filter 43 in combination with each other. The second filter for reception and the second filter for transmission share the same low-pass filter 31, and therefore each filter is partially a dual-purpose filter for transmission and reception, and corresponds to the dual-purpose second filter 20 for transmission and reception of Embodiment 3.

Here, the second switch 60 has the function of selecting the third filter 30 and the fourth filter 40 that are to constitute the second filter from among the plurality of third filters 30 and the plurality of fourth filters 40, and the function of switching the second filter between transmission and reception.

In the second filter for transmission or reception, when the characteristic value of the first variable circuit element 12 is set to the first characteristic value, the first variable circuit element 12 shifts the frequency characteristic of the second filter toward the pass band of the first communication band (e.g., n77), as in the case of the frequency characteristic M2 in FIG. 2. In addition, in the second filter for transmission or reception, when the characteristic value of the first variable circuit element 12 is set to the second characteristic value, the first variable circuit element 12 shifts the frequency characteristic of the second filter toward the pass band of the second communication band (e.g., n79), as in the case of the frequency characteristic M2a in FIG. 2. In this case, if the frequency characteristic of the second filter is to be further shifted toward a higher frequency relative to the frequency characteristic M2a in FIG. 2, for example, the notch filter 33 may be selected instead of the low-pass filter 31. The notch filter 33 has a frequency characteristic in which a specific frequency located close to the lower frequency side of the lower limit frequency of the second communication band (n79) is attenuated. By using the notch filter 33 in combination with the high-pass filter 42 or 43, the attenuation band on the low-frequency side of the frequency characteristic of the second filter is shifted further to the high-frequency side compared to the frequency characteristic M2a in FIG. 2. In this case, however, the second filter becomes a high-pass filter.

Furthermore, a first filter for transmission having a pass band that includes the first communication band (for example, n77) is formed by using the high-pass filter 32 and the low-pass filter 41 in combination with each other.

Furthermore, a first filter for transmission having a pass band that includes the first communication band (for example, n77) is formed by using the high-pass filter 32 and the low-pass filter 44 in combination with each other.

### 4-2 Operation of Radio-Frequency Module 1

### 4-2-1 Operation When Communication is Performed Solely Using Second Communication Band

The operation when communication is performed solely using the second communication band (first case) will be described. In the first case, for example, in the first switch 6, the common terminal 6b is connected to the selection terminal 6d, and the remaining common terminals 6a and 6c are not connected to the selection terminals 6d to 6g. In the second switch 60, the common terminal 60a is connected to the selection terminal 60h, and the remaining common terminals 60a and 60c to 60d are not connected to the plurality of selection terminals 60f to 60i. With these connections, the low-pass filter 31 is selected from among the plurality of third filters 30, and the high-pass filter 43 is selected from among the plurality of fourth filters 40. The selected low-pass filter 31 and high-pass filter 43A form a second filter having a pass band including the second communication band (e.g., n79). In addition, the characteristic value of the first variable circuit element 12 is set to the first characteristic value, and the frequency characteristic of the second filter is shifted toward the first communication band (e.g., n77), as in the case of the frequency characteristic M2 in FIG. 2.

In the above connection state, when the antenna 3b receives a reception signal (second TDD signal), the reception signal passes through the first switch 6, the low-pass filter 31, the second switch 60, the high-pass filter 43, the matching network 53, and the low-noise amplifier 15 and is outputted from the external terminal 5f to the signal processing circuit 2. At this time, because the frequency characteristic of the second filter is shifted toward the first communication band (n77) as in the case of the frequency characteristic M2 in FIG. 2, the insertion loss when the reception signal passes through the second filter is reduced. In other words, the communication quality of communication solely using the second filter can be improved.

### 4-2-2 Operation When Communicating Using First Communication Band and Second Communication Band Simultaneously

The operation will be described below for the case where communication using the first communication band (e.g., transmission) and communication using the second communication band (e.g., reception) are performed simultaneously (second case). In the second case, in the first switch 6, for example, the common terminal 6a is connected to the selection terminal 6e, the common terminal 6b is connected to the selection terminal 6d, and the remaining common terminal 6c is not connected to the selection terminals 6d to 6g. In addition, in the second switch 60, the common terminal 60a is connected to the selection terminal 60h, the common terminal 60b is connected to the selection terminal 60f, and the remaining common terminals 60c and 60d are not connected to the plurality of selection terminals 60f to 60i.

Through these connections, the high-pass filter 32 is selected from among the plurality of third filters 30, and the low-pass filter 41 is selected from among the plurality of fourth filters 40. The selected high-pass filter 32 and low-pass filter 41 form a first filter having a pass band including the first communication band (e.g., n77). The low-pass filter 31 is selected from among the plurality of third filters 30, and the high-pass filter 43 is selected from among the plurality of fourth filters 40. The selected low-pass filter 31 and high-pass filter 43A form a second filter having a pass band including the second communication band (e.g., n79). The characteristic value of the first variable circuit element 12 is set to the second characteristic value, and the frequency characteristic of the second filter 9 is shifted toward the second communication band (e.g., n79) as in the case of the frequency characteristic M2a in FIG. 2. This reduces the overlap between the transition band of the first filter on the second communication band side and the transition band of the second filter on the first communication band side.

In this connection state, when the antenna 3b receives a reception signal (second TDD signal), the reception signal passes through the first switch 6, the low-pass filter 31, the second switch 60, the high-pass filter 43, the matching network 53, and the low-noise amplifier 15 and is outputted from the external terminal 5f to the signal processing circuit 2. Simultaneously with this reception operation, a transmission signal (first TDD signal) is inputted from the signal processing circuit 2 to the external terminal 5d. Then, the transmission signal passes through the external terminal 5d, the power amplifier 13, the matching network 51, the low-pass filter 41, the second switch 60, the high-pass filter 32, and the first switch 6 and is transmitted from the antenna 3a to the outside.

At this time, a portion of the transmission signal leaks from the selection terminal 6d of the first switch 6 to the low-pass filter 31, the second switch 60, and the high-pass filter 43 (i.e., the second filter consisting of the low-pass filter 31 and the high-pass filter 43). However, as described above, by setting the characteristic value of the first variable circuit element 12 to the second characteristic value, the frequency characteristic of the second filter is shifted toward the second communication band, as in the case of the frequency characteristic M2a in FIG. 2. This reduces signal interference in the transition band between the frequency characteristic of the second filter and the frequency characteristic of the first filter 7. Therefore, the portion of the transmission signal passing through the second filter can be reduced. As a result, when the reception signal passes through the second filter, it is possible to reduce the amount of the transmission signal leaking into the second filter that gets mixed into the reception signal. In other words, the reception quality (communication quality) can be improved.

### 4-3 Effects

The radio-frequency module 1 according to Embodiment 4 includes a plurality of third filters 30, a plurality of fourth filters 40, a plurality of low-noise amplifiers 15 and 16, and a plurality of power amplifiers 13 and 14. The plurality of third filters 30 include at least one low-pass filter 31 and at least one high-pass filter 32. The plurality of fourth filters 40 include one or more low-pass filters 41 and 44 and one or more high-pass filters 42 and 43. The plurality of low-noise amplifiers 15 and 16 include the first low-noise amplifier 15. The plurality of power amplifiers 13 and 14 include the first power amplifier 14. The plurality of low-noise amplifiers 15 and 16 are respectively connected to corresponding fourth filters 43 and 44 among the plurality of fourth filters 40. The plurality of power amplifiers 13 and 14 are respectively connected to corresponding fourth filters 41 and 42 among the plurality of fourth filters 40. The first switch 6 selects a connection destination of each of the plurality of antenna terminals 5a to 5c from among the plurality of third filters 30. The second switch 60 selects, from among the plurality of fourth filters 40, the connection destination of the third filter selected by the first switch 6 from among the plurality of third filters 30. During reception using the second communication band, the second filter is formed by one third filter 31 selected by the first switch 6 from among the plurality of third filters 30, and the fourth filter 43 selected by the second switch 60 from among the plurality of fourth filters 40 and connected to the first low-noise amplifier 15. During transmission using the second communication band, the second filter is formed by one third filter 31 selected by the first switch 6 from among the plurality of third filters 30, and the fourth filter 42 selected by the second switch 60 from among the plurality of fourth filters 40 and connected to the first power amplifier 14. During transmission or reception using the first communication band, the first filters 7 and 8 are formed by another third filter 32 selected by the first switch 6 from among the plurality of third filters 30, and the fourth filters 41 and 44 selected by the second switch 60 from among the plurality of fourth filters 40 and connected to the power amplifier 13, which is a power amplifier other than the first power amplifier 14, or the low-noise amplifier 16, which is a low-noise amplifier other than the first low-noise amplifier 15.

According to this configuration, the first filters 7 and 8 and the second filter 20 of Embodiment 3 can be configured by using the third filter 30 selected by the first switch 6 and the fourth filter 40 selected by the second switch 60 in combination with each other, and their frequency characteristics can be changed.

### 4-4 Modification

A modification of Embodiment 4 will be described.

### 4-4-1 Modification 1

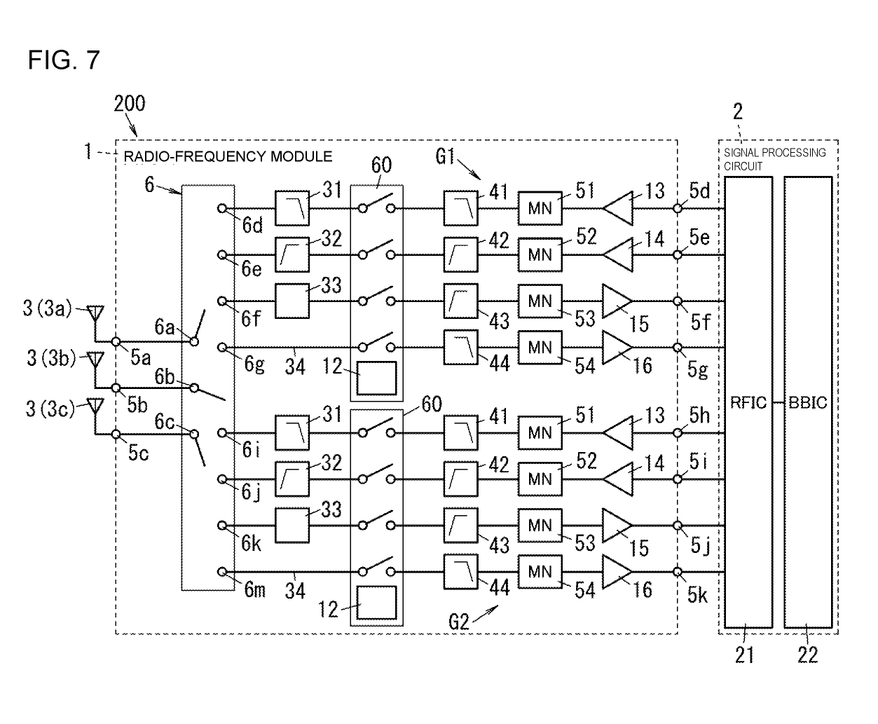

The radio-frequency module 1 according to Embodiment 4 includes one set (hereinafter referred to as a set G1) of a plurality of third filters 31 to 33, the second switch 60, a plurality of fourth filters 40, a plurality of matching networks 51 to 54, the power amplifiers 13 and 14, and the low-noise amplifiers 15 and 16. However, as illustrated in FIG. 7, the radio-frequency module 1 according to Modification 1 further includes another set (hereinafter referred to as a set G2) having the same configuration as the set G1 in the radio-frequency module 1 according to Embodiment 4. That is, the radio-frequency module 1 according to Modification 1 includes multiple sets (two sets G1 and G2 in the example in FIG. 7) of a plurality of third filters 30, the second switch 60, a plurality of fourth filters 40, a plurality of matching networks 51 to 54, the power amplifiers 13 and 14, and the low-noise amplifiers 15 and 16.

The radio-frequency module 1 of Modification 1 further includes a plurality of external terminals 5h to 5k in addition to the components of the radio-frequency module 1 of Embodiment 4.

The external terminal 5h is connected to an output of the signal processing circuit 2 and receives a transmission signal (first TDD signal) outputted from the signal processing circuit 2. The external terminal 5i is connected to an output of the signal processing circuit 2 and receives a transmission signal (second TDD signal) outputted from the signal processing circuit 2. The external terminal 5j is connected to an input of the signal processing circuit 2 and receives a reception signal (second TDD signal) outputted from the radio-frequency module 1. The external terminal 5k is connected to an input of the signal processing circuit 2 and receives a reception signal (first TDD signal) outputted from the radio-frequency module 1.

The first switch 6 of Modification 1 further includes selection terminals 6i to 6k and 6m in addition to the components of the first switch of Embodiment 4.

The first terminals of the plurality of third filters 30 in the set G2 are respectively connected to the plurality of selection terminals 6i to 6k and 6m of the first switch 6. Inputs of the plurality of power amplifiers 13 and 14 and outputs of the plurality of low-noise amplifiers 15 and 16 in the set G2 are respectively connected to the plurality of external terminals 5h to 5k.

The radio-frequency module 1 according to Modification 1 includes a plurality of sets G1 and G2, each set including the second switch 60, the first variable circuit element 12, a plurality of third filters 30, and a plurality of fourth filters 40. This configuration allows multiple reception operations or multiple transmission operations to be performed simultaneously using the same communication band.

### 5 Embodiment 5

### 5-1 Configuration

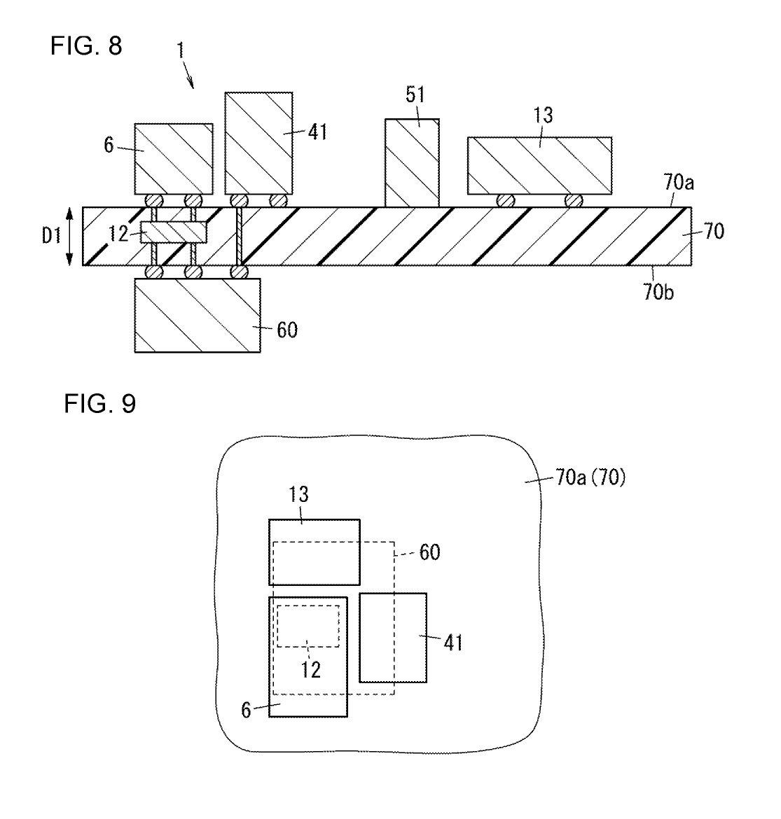

The radio-frequency module 1 according to Embodiment 5 will be described with reference to FIGS. 8 and 9.

In Embodiment 5, an example of the layout of the components of the radio-frequency module 1 according to Embodiment 4 will be described.

As illustrated in FIG. 8, the radio-frequency module 1 according to Embodiment 5 further includes a mounting substrate 70 in addition to the configuration of the radio-frequency module 1 according to Embodiment 4.

In Embodiment 5, the plurality of third filters 31 to 33 are, for example, LC filters or acoustic wave filters. In addition, the plurality of fourth filters 41 to 44 are LC filters, for example.

The mounting substrate 70 has a flat board-like shape, for example. The mounting substrate 70 is, for example, a resin multilayer substrate. Note that the mounting substrate 70 is not limited to being a resin multilayer substrate, and may be, for example, a printed wiring board, a low temperature co-fired ceramic (LTCC) substrate, or a high temperature co-fired ceramic (HTCC) substrate.

The mounting substrate 70 is, for example, a multilayer substrate including a plurality of dielectric layers (insulating layers) and a plurality of conductive layers. Each of the plurality of conductive layers is provided between a plurality of dielectric layers. That is, the plurality of dielectric layers and the plurality of conductive layers are stacked in an alternating manner in a thickness direction D1 of the mounting substrate 70. The plurality of conductive layers are formed in predetermined patterns determined for each layer.

The mounting substrate 70 has a first main surface 70a and a second main surface 70b. The first main surface 70a and the second main surface 70b are main surfaces that face each other in the thickness direction D1 of the mounting substrate 70.

Out of the components of the radio-frequency module 1 according to Embodiment 4, for example, the first switch 6, the second switch 60, the plurality of third filters 30, the plurality of fourth filters 40, the plurality of matching networks 51 to 54, the plurality of power amplifiers 13 and 14, and the plurality of low-noise amplifiers 15 and 16 are disposed on the first main surface 70a. In the example in FIG. 8, only the first switch 6, the fourth filter 41, the power amplifier 13, and the matching network 51 are illustrated. In the example of FIG. 9, only the first switch 6, the third filter 31, and the fourth filter 41 are illustrated.

The second switch 60 is disposed on the second main surface 70b. The first variable circuit element 12 is disposed inside the mounting substrate 70. In Embodiment 4, the first variable circuit element 12 is disposed inside the second switch 60, whereas in Embodiment 5, the first variable circuit element 12 is disposed inside the mounting substrate 70.

The second switch 60 is disposed on the second main surface 70b of the mounting substrate 70, and overlaps at least part of the first switch 6 in plan view in the thickness direction D1 of the mounting substrate 70 (see FIG. 9). This allows the connection wiring between the first switch 6 and the second switch 60 to be made shorter.

The first variable circuit element 12 is disposed inside the mounting substrate 70, and overlaps both the first switch 6 and the second switch 60 in plan view in the thickness direction D1 of the mounting substrate 70 (see FIG. 9). That is, the first variable circuit element 12 overlaps at least part of the first switch 6 and at least part of the second switch 60 in plan view in the thickness direction D1 of the mounting substrate 70. This allows the connection wiring between the first switch 6 and the second switch 60 and the first variable circuit element 12 to be made shorter.

### 5-2 Effects

The radio-frequency module 1 according to Embodiment 5 further includes the mounting substrate 70. The mounting substrate 70 has the first main surface 70a and the second main surface 70b that face each other. The first switch 6 is disposed on the first main surface 70a of the mounting substrate 70. The second switch 10 is disposed on the second main surface 70b of the mounting substrate 70, and overlaps with at least part of the first switch 6 in plan view in the thickness direction D1 of the mounting substrate 70. The first variable circuit element 12 is disposed in the mounting substrate 70.

This configuration allows the connection wiring between the first switch 6 and the second switch 60 to be made shorter. This reduces the likelihood of a resonant circuit being formed by the connection wiring. As a result, it is possible to reduce frequency fluctuations of the first TDD signal and the second TDD signal caused by such a resonant circuit.

Furthermore, in the radio-frequency module 1 according to Embodiment 5, the first variable circuit element 12 is disposed inside the mounting substrate 70. The first variable circuit element 12 overlaps at least part of the first switch 6 and at least part of the second switch 10 in plan view in the thickness direction D1 of the mounting substrate 70.

This configuration allows the connection wiring between the first switch 6 and the second switch 60 and the first variable circuit element 12 to be shortened. As a result, it is possible to reduce frequency fluctuations of the first TDD signal and the second TDD signal caused by a resonant circuit formed by the connection wiring.

### 5-3 Modifications

Next, a modification of Embodiment 5 is described. The following modifications can be implemented in combination with each other.

### 5-3-1 Modification 1

In Embodiment 5, a case is illustrated in which the first variable circuit element 12 is disposed inside the mounting substrate 70. However, the first variable circuit element 12 may be disposed on the first main surface 70a or the second main surface 70b of the mounting substrate 70. According to this configuration, when the first variable circuit element 12 is disposed on the first main surface 70a or the second main surface 70b of the mounting substrate 70, the connection wiring between the first switch 6 and the second switch 60 can be shortened.

Furthermore, when the first variable circuit element 12 is disposed on the first main surface 70a or the second main surface 70b of the mounting substrate 70, the first variable circuit element 12 may be disposed inside an electronic component (e.g., a filter, a matching network, a switch, etc.) disposed on the first main surface 70a or the second main surface 70b of the mounting substrate 70.

Note that Embodiments 1 to 5 and the modifications thereof may be implemented by being combined with each other.

What is claimed is:

1. A radio-frequency module configured to process a first time division duplex (TDD) signal in a first communication band and a second TDD signal in a second communication band adjacent to the first communication band, the first communication band being wider than the second communication band, the radio-frequency module comprising:
a first filter having a first pass band that includes the first communication band;
a second filter having a second pass band that includes the second communication band;
a first switch configured to selectively connect each of a plurality of antenna terminals to a first terminal of the first filter or to a first terminal of the second filter;
a second switch configured to selectively connect a second terminal of the second filter to a first power amplifier or to a first low-noise amplifier; and
a first variable circuit element connected inside the second filter, inside the second switch, or between the second filter and the second switch, and configured to shift an attenuation band in the second filter, the attenuation band being on a first pass band side.

2. The radio-frequency module according to claim 1, further comprising:
a variable matching network connected between the second filter and the second switch,
wherein the first variable circuit element is inside the variable matching network.

3. The radio-frequency module according to claim 1, further comprising:
a second variable circuit element,
wherein the second variable circuit is in the second filter, and
wherein the second variable circuit is a variable filter.

4. The radio-frequency module according to claim 1, further comprising:
a plurality of third filters including at least one low-pass filter and one high-pass filter;
a plurality of fourth filters including at least one low-pass filter and at least one high-pass filter;
a plurality of low-noise amplifiers including the first low-noise amplifier; and
a plurality of power amplifiers including the first power amplifier,
wherein each of the plurality of low-noise amplifiers is connected to a corresponding one of the plurality of fourth filters,
wherein each of the plurality of power amplifiers is connected to a corresponding one of the plurality of fourth filters,
wherein the first switch is configured to selectively connect each of the plurality of antenna terminals to a corresponding one of the plurality of third filters,
wherein the second switch is configured to selectively connect the third filter selected by the first switch to one of the plurality of fourth filters,
during reception with the second communication band, the second filter is formed by one third filter selected by the first switch, and a fourth filter selected by the second switch and connected to the first low-noise amplifier,
during transmission with the second communication band, the second filter is formed by the one third filter selected by the first switch, and a fourth filter selected by the second switch and connected to the first power amplifier, and
during transmission or reception with the first communication band, the first filter is formed by another third filter selected by the first switch, and a fourth filter selected by the second switch and connected to a power amplifier other than the first power amplifier or connected to a low-noise amplifier other than the first low-noise amplifier.

5. The radio-frequency module according to claim 4, further comprising:
a plurality of sets each including the second switch, the first variable circuit element, the plurality of third filters, and the plurality of fourth filters.

6. The radio-frequency module according to claim 1, further comprising:
a mounting substrate having a first main surface and a second main surface facing each other;
wherein the first switch is on the first main surface of the mounting substrate,
wherein the second switch is on the second main surface of the mounting substrate and overlaps at least part of the first switch in a plan view in a thickness direction of the mounting substrate, and
wherein the first variable circuit element is on or in the mounting substrate.

7. The radio-frequency module according to claim 6,
wherein the first variable circuit element is inside the mounting substrate and overlaps at least part of the first switch and at least part of the second switch in the plan view.

8. The radio-frequency module according to claim 6,
wherein the first variable circuit element is on the first main surface or on the second main surface of the mounting substrate.

9. A communication device comprising:
the radio-frequency module according to claim 1; and
a signal processing circuit connected to the radio-frequency module and configured to perform signal processing on a radio-frequency signal.
